(19) United States
(12) Patent Application Publication
(10) Pub. No.: US 2016/0352172 A1
(43) Pub. Date: Dec. 1, 2016

(54) STATOR OF MOTOR, STATOR UNIT AND MANUFACTURING METHOD THEREOF

(71) Applicant: YANG-FUNG FAN, Taipei City (TW)

(72) Inventor: YANG-FUNG FAN, Taipei City (TW)

(21) Appl. No.: 15/164,444

(22) Filed: May 25, 2016

(30) Foreign Application Priority Data
May 28, 2015 (TW) 104117265

(51) Int. Cl. H02K 3/28; H02K 15/02; H02K 15/04; H02K 1/14

(52) U.S. Cl. CPC H02K 3/28; H02K 1/148; H02K 15/02; H02K 15/0435

(57) ABSTRACT

A stator of motor includes a plurality of stator units and a plurality of bushings. The stator units are connected to form a ring. Each stator unit includes a radial slot tooth and an extension arm. The radial slot tooth includes a boot portion, an external circumference opposed to the boot portion, a first side and a second side opposed to the first side. The boot portion is connected to the external circumference through the first side and the second side. The first side has a first engaging portion. The extension arm extends from the second side and the end of the extension arm has a second engaging portion. The first engaging portion of one stator unit is in engagement with the second engaging portion of the adjacent stator unit. The bushings sleeve on the outside of the extension arms respectively, and each bushing is wound by a coil.

### CROSS-REFERENCES TO RELATED APPLICATIONS

This non-provisional application claims priority under 35 U.S.C. §119(a) on Patent Application No. 104117265 filed in Taiwan, R.O.C. on 2015 May 28, the entire contents of which are hereby incorporated by reference.

### BACKGROUND

### Technical Field

The present disclosure relates to a motor component, in particular, relates to a stator of motor, stator unit and manufacturing method thereof.

### Related Art

As the development of technology, the needs of the electric motor (also known as motor) increase. The main function of the motor is to convert electrical energy into mechanical energy including kinetic energy for driving other apparatus. Most of electric motor can produce energy through the magnetic field and the electric current. The electrical motor mainly includes a stator and a rotor. The stator disposed in the motor housing is stationary while the rotor is driven by the interaction of magnetic fields of stator and the rotor to rotate about an axis of rotation to generate the kinetic energy.

The conventional stator 1, as shown in FIG. 1, mainly comprises an annular iron core 10 and a plurality of tooth portions 11. Those tooth portions 11 are disposed on the inner peripheral surface of the annular iron core 10 in spaced relationship and extend toward the center of the annular iron core 10 for forming a plurality of winding slots 12 for winding coils. However, since the winding slots 12 is in an enclosed space circulated by the annular iron core 10 and is of complex shape, the coils winding procedure must be done by special coil-winding equipment. Thus, its manufacturing process is difficult, the procedure is complicated, the processing time is long, and the cost of the equipment is increased.

### SUMMARY

In an embodiment of the present disclosure, a stator of motor comprises a plurality of stator units and a plurality of bushings. The stator units are connected to form a ring. Each stator unit comprises a radial slot tooth and an extension arm. The radial slot tooth comprises a boot portion, an external circumference opposed to the boot portion, a first side and a second side opposed to the first side. The boot portion is connected to the external circumference through the first side and the second side. The first side has a first engaging portion being adjacent to the external circumference. The extension arm extends from the second side and is adjacent to the external circumference, and the end of the extension arm has a second engaging portion. The first engaging portion of one stator unit is in engagement with the second engaging portion of the adjacent stator unit. The bushings sleeve on the outside of the extension arms respectively, and each bushing is wound by a coil.

As described above, according to one embodiment of the present disclosure, the length of the bushing is shorter than the length of the extension arm so that the second engaging portion of the extension arm can protrude out of the bushing to facilitate engaging with the first engaging portion.

As described above, according to one embodiment of the present disclosure, the first side and the second side both are plane surfaces, the first engaging portion is a groove recessed in the first side, and the second engaging portion is a protrusion corresponding to the groove.

As described above, according to one embodiment of the present disclosure, the first engaging portion of one stator unit can be in tight-fitting engagement with the second engaging portion of the adjacent stator unit. Or, the first engaging portion of one stator unit can be engaged with the second engaging portion of the adjacent stator unit by welding or adhering.

As described above, according to one embodiment of the present disclosure, the radial slot tooth comprises at least one aligning hole. The extension direction of the aligning hole is substantially equal to the extension direction of the first engaging portion and the second engaging portion. The boot portion is arc-shaped and comprises a concave arc surface facing to the center of the stator of motor. Thus, in the assembly process, each stator unit can sleeve on a corresponding fixture through the aligning hole and the concave arc surface so that each stator unit can be positioned to avoid shaking or displacement.

In an embodiment of the present disclosure, a stator unit comprises a radial slot tooth and an extension arm. The radial slot tooth comprises a boot portion, an external circumference opposed to the boot portion, a first side and a second side opposed to the first side. The boot portion is connected to the external circumference through the first side and the second side. The first side has a first engaging portion being adjacent to the external circumference. The extension aim extends from the second side and is adjacent to the external circumference, and the end of the extension arm has a second engaging portion. The second engaging portion has the shape corresponding to the first engaging portion for engaging with each other.

In an embodiment of the present disclosure, a manufacturing method of a stator of motor comprises a material-preparing step, a sleeving step, and an assembling step. The material-preparing step is providing a plurality of stator units. The sleeving step is sleeving a plurality of bushings on the outside of the extension arms respectively, whereas each bushing is wound by a coil. The assembling step is engaging the first engaging portion of the stator unit with the second engaging portion of the adjacent stator unit so that the plurality of stator units is connected to form a ring.

In summary, since each bushing of the present disclosure can be wound by the coil first and then sleeve on the outside of the extension aims, compared to the conventional stator, the bushing can be wound without special coil-winding equipment.

Thus, the manufacturing cost is saved effectively, the process is simplified, and the assembling time of the stator of motor is shortened. Furthermore, since the bushing sleeves on the outside of the extension arm, the boot portion can increase the permeability of the stator of motor, improve the operation characteristics of the motor and increase smoothness of operation.

In addition, the stator of motor can be assembled by engaging the first engaging portion with the second engaging portion so that the stator units can be connected to form the ring. Thus, there is no need to assemble additional fixtures or frames to prevent detachment of each stator unit, and further reduce costs.

### BRIEF DESCRIPTION OF THE DRAWINGS

FIG. 1 is a perspective view of a conventional stator.

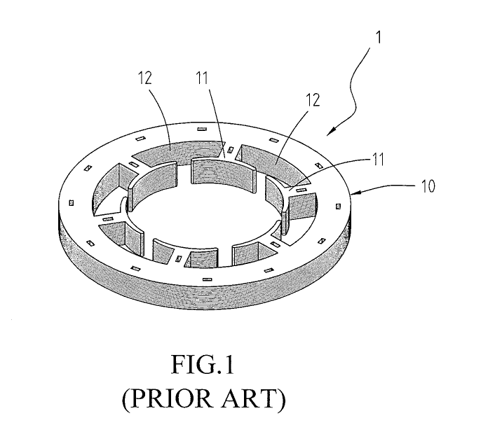

FIG. 2 is a perspective view of a stator of motor according to one embodiment of the present disclosure.

FIG. 3 is an exploded perspective view of a stator unit and a bushing according to one embodiment of the present disclosure.

FIG. 4 is an exploded perspective view of a stator according to one embodiment of the present disclosure.

FIG. 5 is another exploded perspective view of a stator according to another embodiment of the present disclosure.

FIG. 6 is a top view of a stator of motor according to one embodiment of the present disclosure.

FIG. 7 is a perspective view of a stator unit according to another embodiment of the present disclosure.

FIG. 8 is a top view of a stator of motor according to another embodiment of the present disclosure.

FIG. 9 is an exploded perspective view of a stator unit according to another embodiment of the present disclosure.

FIG. 10 is a flow chart illustrating a manufacturing method of a stator of motor according to one embodiment of the present disclosure.

### DETAILED DESCRIPTION

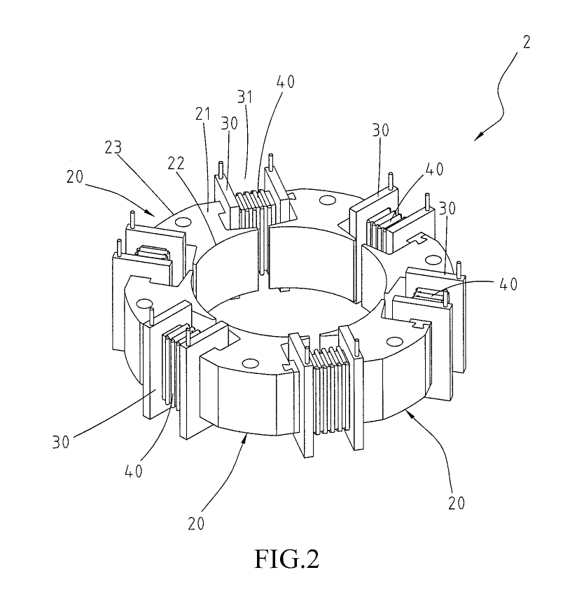

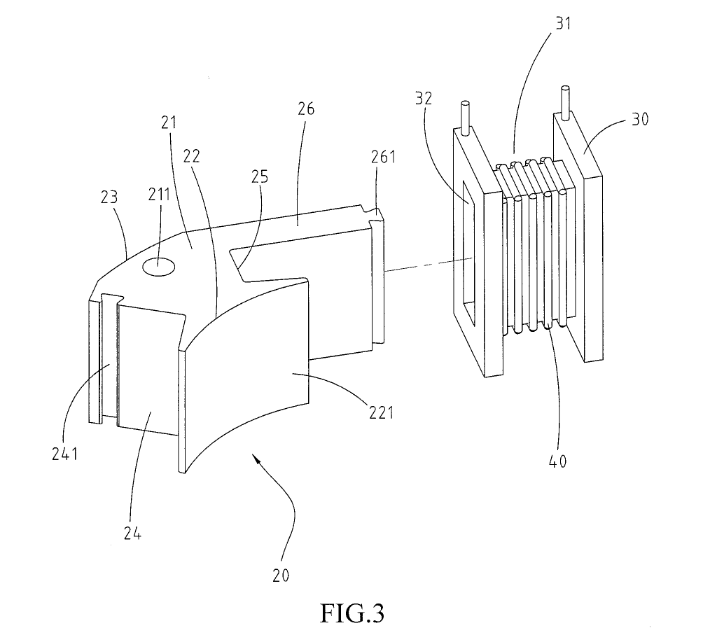

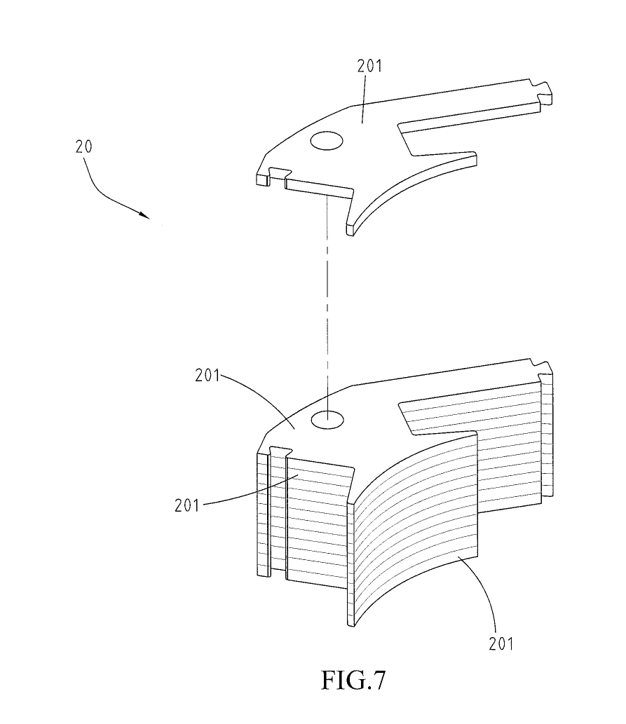

Please refer to FIGS. 2 and 3. The stator of motor 2 comprises a plurality of stator units 20 and a plurality of bushings 30. The stator units 20 are connected together to form a ring. In this embodiment, each stator unit is one piece component. Alternatively, as shown in FIG. 7, in another embodiment, each stator unit can be a module by stacking up a plurality of soft magnetic members 201. The soft magnetic member 201 may be a sheet shape and made of at least one of soft magnetic materials such as iron, cobalt, nickel, or silicon steel. The soft magnetic members 201 can be combined by an adhesive or riveted joint. Or, in other embodiment, each stator unit 20 can be a single soft magnetic sheet. Multiple stator units 20 are stacked up into a module, and multiple modules can be connected to form a ring shape. It is to be noted that, the assembling structure of the stator units 20 and the ring is not intended to limit the scope of the instant disclosure.

Each stator unit 20 comprises a radial slot tooth 21 and an extension arm 26. The radial slot tooth 21 comprises a boot portion 22, an outer circumference 23 opposed to the boot portion 22, a first side 24 and a second side 25 opposed to the first side 24. In this embodiment, the boot portion 22 is near the center of the ring, compared to the outer circumference 23. Namely, each boot portion 22 is at the inner peripheral surface of the stator of motor 2, and the outer circumference 23 is at the outer peripheral surface of the stator of motor 2. The boot portion 22 is connected to the outer circumference 23 through the first side 24 and the second side 25.

The first side 24 and the second side 25 both are plane surfaces (namely, flat surfaces), and the first side 24 and the second side 25 are slant to the middle area of the boot portion 22. The first side 24 has a first engaging portion 241. In this embodiment, the first engaging portion 241 is a dovetail groove, which is recessed in the first side 24 and extends along the axis of the ring. The first engaging portion 241 is near the outer circumference 23.

The extension arm 26 extends from the second side 25 and is adjacent to the outer circumference 23 so that the appearance of the stator unit 20 is approximately 7-shaped. The extension arm 26 is approximately stick-shaped, and the outer surface of the extension aim 26 is connected to the outer circumference 23. In this embodiment, two side surfaces of the extension arm 26 are substantially perpendicular to the second side 25. Namely, the extension arm 26 is substantially a rectangular block. Furthermore, the end of the extension arm 26, which is opposed to the second side 25, has a second engaging portion 261. The second engaging portion 261 can be a protrusion corresponding to the dovetail groove, and the protrusion extends along the axis of the ring matching the dovetail groove. In another embodiment, the first engaging portion 241 can be a protrusion, and the second engaging portion 261 can be a groove corresponding to the protrusion. It is to be noted that there are many corresponding structures adapted for engaging the first engaging portion 241 with second engaging portion 261 and those are not enumerated. The disclosed corresponding structures are not intended to limit the scope of the instant disclosure and the scope of the instant disclosure should include those undisclosed corresponding engaging structures.

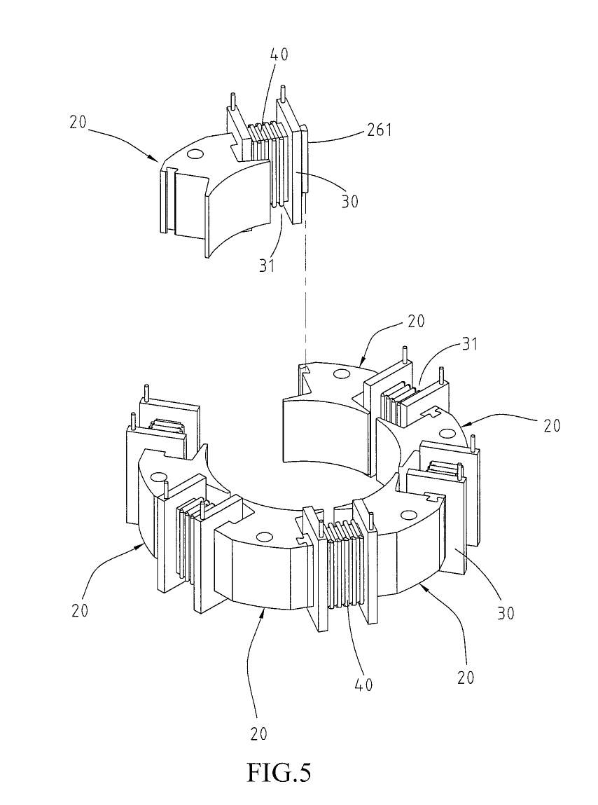

Please refer to FIG. 5. The first engaging portion 241 of one stator unit 20 is in tight-fitting engagement with the second engaging portion 261 of the adjacent stator unit 20. In this embodiment, the second engaging portion 261 of one stator unit 20 is pressed to be fitted in tight-fitting engagement with the first engaging portion 241 of the adjacent stator unit 20 so that the stator units can be connected together to form the ring. Thus, there is no need to assemble additional fixtures or frames to prevent from detachment of stator units 20 and the cost is further reduced. In other embodiment, the first engaging portion 241 of one stator unit 20 is engagement with the second engaging portion 261 of the adjacent stator unit 20, and an additional fixture or a frame is used for preventing from detachment of stator units 20. Or, in yet another embodiment, the first engaging portion 241 of one stator unit 20 can be engaged with the second engaging portion 261 of the adjacent stator unit 20 by welding or adhering. It is to be noted that, the disclosed engagement ways of the first engaging portion 241 and the second engaging portion 261 are not intended to limit the scope of the instant disclosure.

Furthermore, as shown in FIG. 7, the stator unit 20 is formed by stacking up a plurality of soft magnetic members 201 so that the iron loss and the eddy-current loss are reduced and the mold for the stator unit 20 is easier to produce. Compared to one-piece stator unit, the stator unit 20 stacked up by the soft magnetic members 201 can improve the joining effect between the first engaging portion 241 and the second engaging portion 261. Specifically, when the first engaging portion 241 of one stator unit 20 is in engagement with the second engaging portion 261 of the adjacent stator unit 20, the frictional force between the first engaging portion 241 and the second engaging portion 261 is enhanced and the joining effect is enhanced, too.

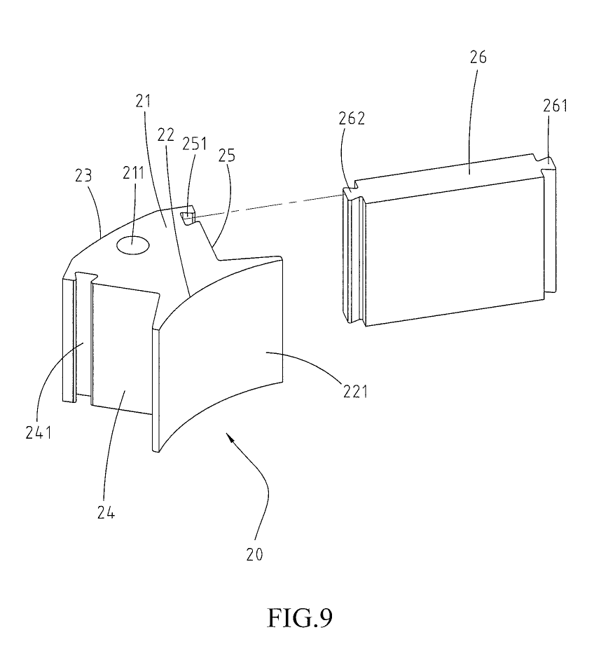

In addition, in another embodiment, each stator unit 20, except being one piece component (shown in FIG. 3), can be combined by separate components. According to the embodiments shown in FIG. 9 is that the radial slot tooth 21 is detachably connected to the extension arm 26. The second side 25 shown in FIG. 9 has a third engaging portion 251. In this embodiment, the third engaging portion 251 is a dovetail groove, which is recessed in the second side 25. The extension aim 26 has a fourth engaging portion 262, which can be a protrusion corresponding to the dovetail groove. The third engaging portion 251 of the radial slot tooth 21 is in tight-fitting engagement with the fourth engaging portion 262 of the extension arm 26 to form the stator unit 20 shown in FIG. 9. In practice, the structure of the third engaging portion 251 of the radial slot tooth 21 is corresponding to the structure of the fourth engaging portion 262 of the extension arm 26. It is to be noted that there are many corresponding structures adapted for engaging the third engaging portion 251 with the fourth engaging portion 262.

The bushings 30 sleeve on the outside of the extension arms 26, respectively, and a coil 40 is wound around each of the bushing 30. In this embodiment, the bushing 30 has a winding groove 31, and the coil 40 is wound on the winding groove 31 to prevent the coil 40 from being apart from the bushings 30. The length of each bushing 30 is shorter than the length of the corresponding extension arm 26 so that the second engaging portion 261 of the extension arm 26 can protrude out of the bushing 30 to facilitate engaging with the first engaging portion 241 of the adjacent stator unit 20.

Thus, the bushings 30 of the present disclosure can be wound by the coil 40 first and then sleeve on the extension arms 26. Compared to the conventional stator, the bushing 30 of the stator of motor 2 can be wound without special coil-winding equipment. Thus, the manufacturing cost is saved effectively, the process is simplified, and the winding time of the stator of motor 2 is shortened. Furthermore, since the bushing 30 sleeves on the extension arm 26, the boot portion 22 can increase the permeability of the stator of motor 2, improve the operation characteristics of the motor and increase smoothness of operation. Besides, since the bushing 30 can extra sleeve on the outside of the extension arm 26, the stator units 20 can be one piece component. Thus, the stator units 20 has better structural strength and decrease the components of the stator of motor 2 for increasing production efficiency.

The radial slot tooth 21 of the stator units 20 comprises at least one aligning hole 211. In this embodiment, the aligning hole 211 is a circular through hole and the extension direction of the aligning hole 211 is substantially parallel to the extension direction of the first engaging portion 241 and the second engaging portion 261. The boot portion 22 is arc-shaped and comprises a concave arc surface 221. The concave arc surface 221 faces to the center of the stator of motor 2 and is corresponding to the radian of outer surface of the motor rotor. Thus, the induction area increases as well as the magnetic leakage is reduced for increasing the permeability. Furthermore, in other embodiment, the aligning hole 211 is a blind hole at the outer circumference 23 of the radial slot tooth 21 or the concave arc surface 221 of the boot portion 22. The disclosed positioning and the type of the aligning holes 211 are not intended to limit the scope of the instant disclosure.

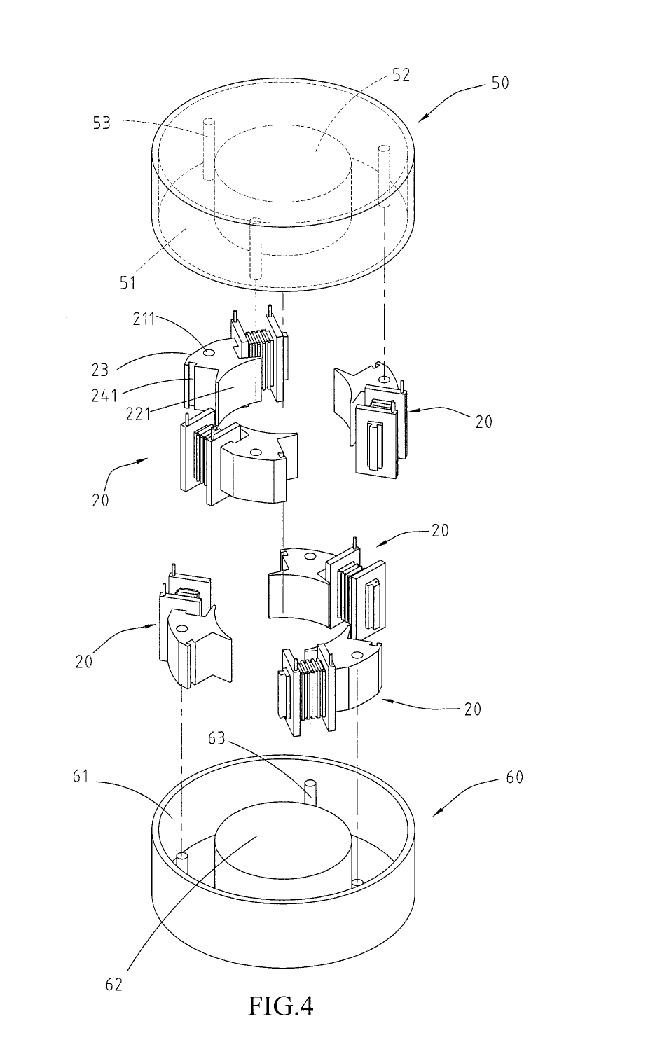

Furthermore, in the assembly process, each stator unit 20 can sleeve on a corresponding fixture through the aligning hole 211 and the concave arc surface 221 so that each stator unit 20 can be positioned to avoid shaking or displacement. Please, refer to FIG. 4. Specifically, in the assembly process, those the stator units 20 can be assembled by use of an upper fixture 50 and a lower fixture 60. The upper fixture 50 has a circular trough 51, a cylinder 52, and a plurality of protruding pillars 53, and the protruding pillars 53 are in the circular trough 51. The lower fixture 60 has a circular trough 61, a cylinder 62, and a plurality of protruding pillars 63, and the protruding pillars 63 are in the circular trough 61. In this embodiment, there are six stator units 20 to be assembled into a ring. Three of the stator units 20 are arranged in the circular trough 51 of the upper fixture 50 in spaced relationship. The concave arc surfaces 221 of the three stator units 20 against the circumferential surface of the cylinder 52, and the aligning holes 211 of the three stator units 20 sleeve on the corresponding protruding pillars 53 of the upper fixture 50, respectively, for positioning these stator units 20. Another three of the stator units 20 are arranged in the circular trough 61 of the lower fixture 60 in spaced relationship. The concave arc surfaces 221 of the stator units 20 are against the circumferential surface of the cylinder 62, and the aligning holes 211 of stator units 20 sleeve on the corresponding protruding pillars 63 of the lower fixture 60, respectively, for positioning those stator units 20. It is to be noted that, the stator units 20 in the upper fixture 50 are staggered from the stator units 20 in the lower fixture 60. Then, the upper fixture 50 and the lower fixture 60 are pressed together so that the stator units 20 are connected together to form the ring. In this embodiment, since each stator unit 20 is an integral module, the stator of motor 2 is assembled by a group of fixtures (namely, the upper fixture 50 and the lower fixture 60). Thus, the manufacturing method of the stator of motor 2 can be quicker and easier.

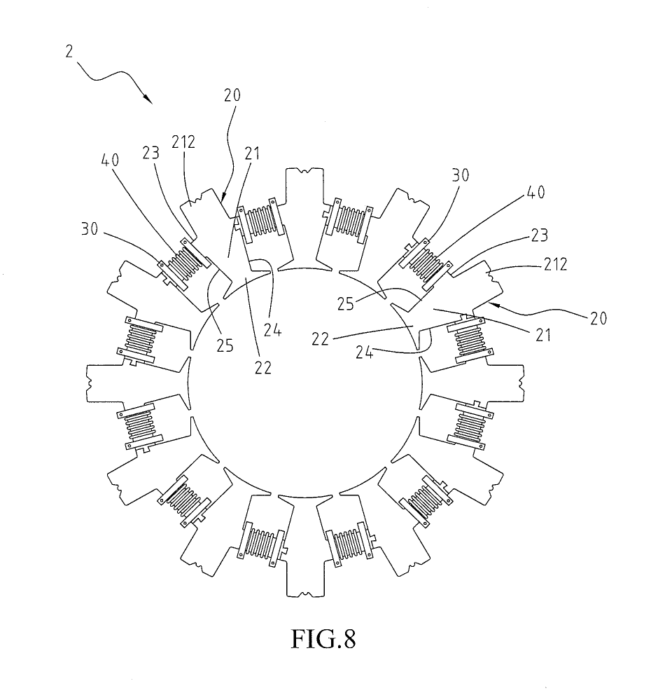

Please refer to FIG. 8. In this embodiment, the stator units 20 comprises a protective protrusion 212 connected to the outer circumference 23 and extends radially and outwardly from the outer circumference 23. In other words, the protective protrusion 212 extends along the direction opposed to the boot portion 22 so that the outlook of the stator unit 20 is substantially T-shaped. When the thickness of the coil 40 is thicker than the winding groove 31 of the bushing 30, the protective protrusion 212 protects the coil 40 or the bushing 30 from worn by contact with other components during the installation of the stator of motor 2 in the motor housing. Namely, in order to protect the coil 40 or the bushing 30, the radial distance of the outer surface of the protective protrusion 212 from the center of the ring is designed to be farer than the radial distance of outermost point of overall thickness of bushing 30 including the coil 40 from the center of the ring. Thus, the stator of motor 2 can be installed in the motor housing after being assembled without the abrasion of the bushing 30 and the coil 40 so that the manufacturing method of the stator of motor 2 can be quicker and easier.

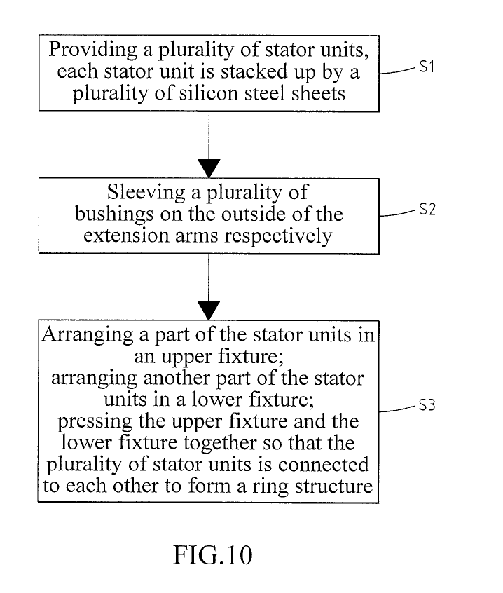

Please refer to FIG. 10. The manufacturing method of the stator of motor 2 comprises the following steps.

In a material-preparing step S 1, the plurality of stator units 20 is provided. In this embodiment, each stator unit 20 can be a one-piece component, as shown in FIG. 3. Or, in another embodiment, each stator unit can be a module formed by stacking up a plurality of soft magnetic members 201, as shown in FIG. 7.

Next, in a sleeving step S2, a plurality of bushings 30 sleeve on the outside of the extension arms 26 respectively, whereas the second engaging portion 261 of the extension arm 26 protrudes out of the bushing 30. The bushing 30 is made of insulating material like plastic. The bushing 30 has the winding groove 31 and a through opening 32 and the coil 40 is wound on the winding groove 31. Since the bushing 30 can extra sleeve on the outside of the extension arm 26, compared to the conventional stator, the coil 40 can be wound on the winding groove 31 of the bushing 30 by general coil-winding equipment without being not blocked from the stator unit 20 during winding process.

Next, in an assembling step S3, as shown in FIG. 4, three of the stator units 20 are arranged in the circular trough 51 of the upper fixture 50 at spaced relationship. The concave arc surfaces 221 of the three stator units 20 are against the circumferential surface of the cylinder 52, and the aligning holes 211 of the stator units 20 sleeve on the corresponding protruding pillars 53 of the upper fixture 50, respectively, for positioning these stator units 20. Another three the stator units 20 are arranged in the circular trough 61 of the lower fixture 60 in spaced relationship. The concave arc surfaces 221 of the stator units 20 are against the circumferential surface of the cylinder 62, and the aligning holes 211 of stator units 20 sleeve on the corresponding protruding pillars 63 of the lower fixture 60, respectively, for positioning those stator units 20. It is to be noted that, the stator units 20 in the upper fixture 50 are staggered from the stator units 20 in the lower fixture 60. Then, the upper fixture 50 and the lower fixture 60 are pressed together so that the stator units 20 are connected to form the ring. In other words, in the assembling step S3, some the stator units 20 are arranged in the upper fixture 50 in spaced relationship, then others are arranged in the lower fixture 60 corresponding to the spaced intervals between adjacent stator units 20 in the upper fixture 50. Thus, the first engaging portions 241 of the stator units 20 are aligned with the second engaging portion 261 of the adjacent stator units 20. Then, the upper fixture 50 and the lower fixture 60 are pressed together so that the stator units 20 are connected to form the ring.

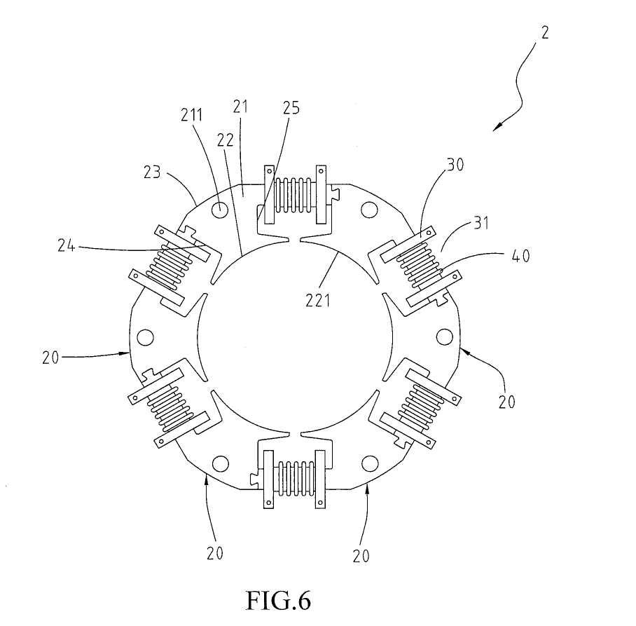

Or, as shown in FIG. 5. In other embodiment, in the assembling step S3, the first engaging portion 241 of one stator unit 20 is in tight-fitting engagement with the second engaging portion 261 of the adjacent stator unit 20 directly so that the stator units can be connected to form the ring, namely, the stator of motor 2 (shown in FIGS. 2 and 6).

In summary, since the bushings of the present disclosure can be wound by the coil first and then sleeve on the outside of the extension arms, compared to the conventional stator, the bushing can be wound without special coil-winding equipment. Thus, the manufacturing cost is saved effectively, the process is simplified, and the assembling time of the stator of motor is shortened. Furthermore, since the bushing sleeves on the outside of the extension arm, the boot portion can increase the permeability of the stator of motor, improve the operation characteristics of the motor and increase smoothness of operation.

In addition, the stator of motor can be assembled by engaging the first engaging portion with the second engaging portion so that the stator units can be connected to form the ring. Thus, there is no need to assemble additional fixtures or frames to prevent detachment of each stator unit, and further reduce costs.

While the present disclosure has been described by way of example and in terms of the preferred embodiments, it is to be understood that the invention needs not be limited to the disclosed embodiments. For anyone skilled in the art, various modifications and improvements within the spirit of the instant disclosure are covered under the scope of the instant disclosure. The covered scope of the instant disclosure is based on the appended claims.

What is claimed is:

1. A stator of motor, comprising:
a plurality of stator units connected to form a ring, each stator unit comprising a radial slot tooth and an extension arm, wherein the radial slot tooth comprises a boot portion, an external circumference opposed to the boot portion, a first side and a second side opposed to the first side, and the boot portion is connected to the external circumference through the first side and the second side, and the first side has a first engaging portion being adjacent to the external circumference, and the extension aim extends from the second side and is adjacent to the external circumference, and the end of the extension arm has a second engaging portion, wherein the first engaging portion of one stator unit is in engagement with the second engaging portion of the adjacent stator unit; and
a plurality of bushings, sleeving on the outside of the extension arms respectively, wherein each bushing is wound by a coil.

2. The stator of motor of claim 1, wherein each stator unit is stacked up by a plurality of soft magnetic members.

3. The stator of motor of claim 1, wherein the first engaging portion is a groove, and the second engaging portion is a protrusion corresponding to the groove.

4. The stator of motor of claim 1, wherein the first engaging portion of one stator unit is in tight-fitting engagement with the second engaging portion of the adjacent stator unit.

5. The stator of motor of claim 1, wherein the length of the bushing is shorter than the length of the extension aim.

6. The stator of motor of claim 1, wherein the radial slot tooth comprises at least one aligning hole.

7. The stator of motor of claim 1, wherein the boot portion is arc-shaped and comprises a concave arc surface.

8. The stator of motor of claim 1, wherein the radial slot tooth comprises a protective protrusion connected to the external circumference and extends outwardly from the external circumference.

9. The stator of motor of claim 1, wherein the radial slot tooth is detachably connected to the extension arm, the second side of the radial slot tooth has a third engaging portion, one end of the extension arm near the radial slot tooth has a fourth engaging portion, and the third engaging portion is in tight-fitting engagement with the fourth engaging portion.

10. A stator unit, comprising:
a radial slot tooth comprising a boot portion, an external circumference opposed to the boot portion, a first side and a second side opposed to the first side, wherein the boot portion is connected to the external circumference through the first side and a second side, and the first side has a first engaging portion being adjacent to the external circumference; and
an extension arm extending from the second side and is adjacent to the external circumference, and the end of the extension arm has a second engaging portion, wherein the second engaging portion has the shape corresponding to the first engaging portion for engaging with each other.

11. The stator unit of claim 10, wherein the stator unit is stacked up by a plurality of soft magnetic members.

12. The stator unit of claim 10, wherein the first engaging portion is a groove, and the second engaging portion is a protrusion corresponding to the groove.

13. The stator unit of claim 10, wherein the radial slot tooth comprises at least one aligning hole.

14. The stator unit of claim 10, wherein the boot portion is arc-shaped and comprises a concave arc surface.

15. The stator unit of claim 10, wherein the radial slot tooth comprises a protective protrusion connected to the external circumference and extends outwardly from the external circumference.

16. The stator unit of claim 10, wherein the radial slot tooth is detachably connected to the extension aim, the second side of the radial slot tooth has a third engaging portion, one end of the extension arm near the radial slot tooth has a fourth engaging portion, and the third engaging portion is in tight-fitting engagement with the fourth engaging portion.

17. A manufacturing method of a stator of motor, comprising:
a material-preparing step: providing a plurality of stator units, wherein each stator unit comprises a radial slot tooth and an extension arm, wherein the radial slot tooth comprises a boot portion, an external circumference opposed to the boot portion, a first side and a second side opposed to the first side, and the boot portion is connected to the external circumference through the first side and a second side, and the first side has a first engaging portion being adjacent to the external circumference, and the extension arm extends from the second side and is adjacent to the external circumference, and the end of the extension arm has a second engaging portion, wherein the second engaging portion have the shape corresponding to the first engaging portion for engaging with each other;
a sleeving step: sleeving a plurality of bushings on the outside of the extension arms respectively, wherein each bushing is wound by a coil; and
an assembling step: engaging the first engaging portion of the stator unit with the second engaging portion of the adjacent stator unit so that the plurality of stator units is connected to form a ring.

18. The manufacturing method of claim 17, wherein the material-preparing step comprises stacking up a plurality of soft magnetic members and punching into the stator unit.

19. The manufacturing method of claim 17, wherein in the material-preparing step, the radial slot tooth is detachably connected to the extension arm, the second side of the radial slot tooth has a third engaging portion, one end of the extension arm near the radial slot tooth has a fourth engaging portion, and the third engaging portion is in tight-fitting engagement with the fourth engaging portion.

20. The manufacturing method of claim 17, wherein assembling step further comprises:
arranging a part of the stator units in an upper fixture and another part of the stator units in a lower fixture, wherein the stator units in the upper fixture are staggered from the stator units in the lower fixture; and
pressing the upper fixture and the lower fixture together.
